(19) United States
(12) Patent Application Publication
(10) Pub. No.: US 2002/0087693 A1
(43) Pub. Date: Jul. 4, 2002

(54) Method and system for distributing service functionality

(76) Inventors: Donald Brent Marshall, Ottawa (CA); Elaine El lay Quah, Nepean (CA); Bryn P. Rahm, Kanata (CA)

Correspondence Address: Hunton & Williams, 1900 K Street, N.W., Washington, DC, 20006-1109, US

(21) Appl. No.: 09/749,937

(22) Filed: Dec. 29, 2000

(51) Int. Cl. G06F 15/173

(52) U.S. Cl. 709/226

(57) ABSTRACT

The present invention provides more flexible engineering of network computing resources based on the actual needs of the customer, the resource requirements of the service and other relevant factors. The present invention relates to efficient use of network resources. By having the option of placing a particular function within a service on a node where it naturally fits according to its functional couplings, the inter-node communication may be reduced. As a result, the overall processing costs of the service may be minimized and efficiencies are enhanced.

### FIELD OF THE INVENTION

The present invention relates generally to a system and method for enabling the distribution of service functionality across network elements, as the natural couplings of the service software and the engineering attributes of the network dictate, where other efficiency factors and considerations may also be considered.

### BACKGROUND OF THE INVENTION

In networks, there may often exist incompatibilities among various components and other hardware. For example, in a wide area network, different servers, databases or communication links may have different requirements which, if substituted, may interrupt communications.

As another example, in a cell phone network, different cell phone equipment may have varying requirements for proper and efficient communication. Generally, a cell phone (or other communication device) may transmit to a mobile switching office which may be used to translate phone numbers (or other identifiers) to connect the transmitting party to the desired one or more recipients. The mobile switching office may receive cell phone (or other) transmissions and route the transmissions to the network, resource (e.g., database) or other entity. Generally, a server may be configured to format to a specific database (or other resource). A resource, for example, may include anything which may be needed for a service to execute successfully, such as a database, network addresses, switches, hardware, software, control logic and other components. Each component of a network is dependent on each other for compatibility and proper communication.

If a database (or other resource) is to be removed (or otherwise modified), reconfiguration of the server and other components may be required. This may entail downing the system, making the necessary modifications, loading software, rebooting, and performing other additional operations. Thus, if a phone server (or other types of resources) are modified (e.g., upgraded, etc.), changes in hardware and other components in a mobile switching office or other network elements may be necessary.

Currently, modifications (including upgrades) in a network (such as a cell phone network) are difficult and time consuming due to the dependency on components within the network.

Essentially, every device in a chain had to know the identity and type of devices in the rest of the chain to obtain the requested information. Therefore, modifications and upgrades have been difficult and tedious because components are dependent on hardware and other components within a network. Generally, system crashes and other impediments occur when modifying resources, such as upgrades in databases.

Since services interact with many types of nodes to implement service functionality, this generally requires protocols to be implemented between/among service nodes and other nodes. Oftentimes, services need to be developed that require access to information or functionality which may be accessible on the nodes, but not accessible via the protocol. This generally involves extending the protocol on both nodes. As a result, new releases of the platform software may be required on both nodes in order to effectively deliver the new service. One of the consequences of this limitation include a time-to-market delay for new services where the services are often limited by the slowest software delivery cycle of all the nodes in the network.

Creation of services by service providers, third parties, or other entities may be severely limited. For example, innovative services may require extensions to base software on nodes in a network. In some cases, the service functionality may be tightly coupled to one or more of the specialized nodes in the network, requiring long, complex sequences of messaging between the nodes and/or other complicated operations. In such cases, the processing of these protocol messages, and the transaction context switches required on both nodes may represent a major portion of the computing required on each node. This results in the need for increased computing resources in the nodes.

Thus, attempts have been made to localize service functionality on a single type of node in a network, such as Service Control Point (“SCP”) in Intelligent Networks (“IN”). In another example, Common Object Request Broker Architecture (“CORBA”) enables the distribution of coupled software throughout a network requiring protocol development for interaction. However, CORBA and other attempts do not effectively provide a general framework for the deployment and execution of services, and the management of distributed transaction contexts.

Traditionally, a central service node may have various processing capabilities. Generally, the various components of a network may interact with the central service node for communication and/or exchange with other components in the network. However, the use of a central service node in a network generally necessitates multiple inter-nodal exchanges where communication between/among nodes is accomplished indirectly through the central service node. As a result, these systems require large overhead and result in delays and inefficiencies.

### SUMMARY OF THE INVENTION

The present invention provides a method and system for enabling the distribution of service functionality across network elements, as the natural couplings of the service software and the engineering attributes of the network dictate. Other efficiency factors may also be considered in the distribution of service functionality. The present invention further enables service software to reside on a network element to which it is most tightly coupled, reducing the overall computing and messaging requirements of the network. Thus, costs may be reduced and efficiencies may be realized.

Different software components constituting parts of the same (or related) service may execute on different nodes in a network. Therefore, the service context representing an instance of the executing service may be physically distributed on different nodes. A service logic execution engine (“SEE”) may make this feature transparent to the software components implementing the service.

For example, if an event is raised by a software component on one physical node, and a software component executing on another node is listening for that event, the SEE may transmit the event to the other node. The remote SEE may then receive the event, determine the appropriate service context (if any) to invoke, and pass the event into the appropriate software component in that service context. A service context may involve a collection of software components applicable to a session.

The present invention further enables multiple parallel servers to execute the same (similar, or related) service, so that the throughput of services may be scaled to a level a service provider desires or as otherwise may be determined. The present invention may further allow parts of a service to execute on different network nodes from each other without requiring the implementation of a protocol for the communication between the different parts.

Other objects, features and advantages of the present invention will be apparent through the detailed description of the preferred embodiments and the drawings attached hereto. It is also to be understood that both the foregoing general description and the following detailed description are exemplary and explanatory and not restrictive of the scope of the invention.

### BRIEF DESCRIPTION OF THE DRAWINGS

FIG. 1 is a diagram of an architecture which may support an open programmability environment, according to an embodiment of the present invention.

FIG. 2 is a diagram of a system with typical inter-node interactions.

FIG. 3 is a diagram of a system where services have been distributed, according to an embodiment of the present invention.

FIG. 4 is a flowchart of a method for enabling distribution of service functionality across network elements, according to an embodiment of the present invention.

### DETAILED DESCRIPTION OF THE PREFERRED EMBODIMENTS

The present invention relates to a method and system for addressing incompatibility issues related to hardware and other components in a network. The present invention enables a network (e.g., cell phone network) to be programmable at a higher level without restructuring or tearing down an existing system. Thus, the system of the present invention provides improved reliability by minimizing system crashes; facilitates upgrades, additions and deletions; and provides other advantages.

The present invention relates to the distribution of service functionality throughout the network as the couplings and engineering considerations of the service components dictate, without the components constituting the service needing to be aware of the physical distribution of this distribution.

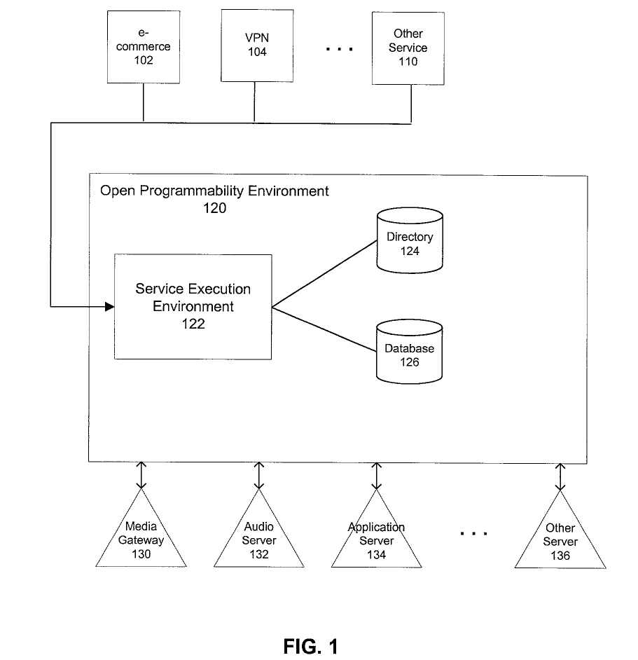

FIG. 1 illustrates an example of an architecture for supporting a system providing an open programmability environment, according to an embodiment of the present invention.

An open programmability environment 120 of the present invention provides an environment where, among other things, hardware components do not need to be hardwired to other specific types of components for communication. Instead, various data structures and control logic may be processed in order to establish proper communication with varying and multiple devices. Thus, data of differing types and variations may be received and processed without restructuring or reconfiguring the overall system.

The open programmability environment 120 of the present invention may include hardware, software, communication and other resources. As illustrated in FIG. 1, the open programmability environment 120 may support resources including a service execution environment 122, Directory 124 and Database 126. Other resources may also be included. Generally, a resource may include anything which may be needed for a service to execute successfully. For example, in a telephone network implementation, a resource may include a database, network addresses, switches, and other hardware, software, control logic or other components used to support connections. Other implementations, variations and applications may be used.

A variety of services may execute within the Service Execution Environment 122 of the Open Programmability Environment 120. These services may include, for example Virtual Private Network (“VPN”) 104, e-Commerce 102, and other service 110. These services may be accessed by a variety of means including web browsers, mobile phones, voice menus, etc.

Back-end processing may occur, for instance, through Media Gateway 130, Audio Server 132, Application Server 134, and other servers 136.

Distributed services of the present invention may involve a service logic execution engine (SEE) which may execute on a specialized type of node in a network, or on other nodes which may have different specialized functions. Thus, the SEE enables service logic to execute (or run) on any of the nodes in a network. Each service may consist of several components, which may be distributed to different nodes, as needed or required. Components may execute wherever the physical resources they require are located. Various efficiency and other factors may also be considered in deciding where (e.g., which node) execution of each component is to occur.

Components of a service may communicate using events or other communication mechanism. Also, the physical location and other information of service logic components may be transparent to the service. The SEE framework may be used to pass events to remote SEES, as needed or required.

The Open Programmability Environment (“OPE”) service logic execution engine (“SEE”) may be deployed to any Java-enabled (or otherwise programmable) node in a network. This may include dedicated application servers, switches, media gateways, announcement service, end-users' client devices and other devices. Constituent parts of a service (e.g., application components) may execute in a node which is natural and efficient, based on their intrinsic functionality and other factors and circumstances.

Application components constituting a service may communicate with each other (and/or other entities) using events (or other communication mechanisms). The event passing relationships between application components may be defined using an OPE “Wiring Tool”, for example. This may occur before the service is deployed to the network. Other deployment processes may also be utilized.

When a service is deployed to various nodes in a network, the SEE (or other execution mechanism) may create appropriate local and/or remote references. This enables events to be sent between application components regardless of their location in the network. When an application component sends an event to another application component at runtime, the SEE may make the localness and/or remoteness of the sender and receiver transparent.

The present invention further enables the same (similar or related) application component to be deployed to many servers in parallel in a network to increase the total throughput of a service, which may be computationally intensive or extremely well used, for example. When this occurs and an event is sent to the application component which may be distributed to many parallel nodes, the appropriate node may be selected. A resource manager (or other retrieval device) may be used to retrieve the reference to a remote application component. When the resource ID of the remote application component is passed to the resource manager, it may be used to retrieve the address of (or a proxy to communicate with) the remote node to which the event should be sent. The one or more appropriate node may be based on factors that provide for efficient and/or optimal operations. Based on resource type, a resource resolution mechanism may be used to retrieve the specific resource. Other retrieval methods may also be utilized.

According to another embodiment of the present invention, when multiple parallel nodes are executing the same (similar or related) application component, a resource resolution mechanism may use a “selection function” to determine the node which should be invoked. This selection function may execute an algorithm, for example, to determine which node to execute. Various efficiency and/or other factors may be considered in deciding which node to execute. Algorithms may include round robin scheduling, least busy, or others.

According to another example of the present invention, many services may maintain a context (or session) for a period of time. Such services may include a telephone call, a stock market order entry session, etc., for example. The SEE may maintain the contexts for each application component. Further, the SEE may maintain the associations between the application components contexts which constitute a service context. Thus, when events are sent from an application component on one node to an application component on another node, the SEE may ensure that the event is sent to the appropriate context within the receiving application component.

In addition, the SEE may manage the normal and abnormal terminations of the collective, distributed contexts of a service. Each application component may be designated as a “context-master” or “context-slave”. Other options may also be available. For example, context-masters may explicitly release their context. Context-slaves may have their contexts implicitly released whenever an associated context-master releases its context. Optionally, an application component may be informed before this occurs, so that the application component may perform a terminating action before the context is released.

For example, when a context-master releases its context, all of its context-slaves may have their context released, regardless of whether they are co-located located with the master. This may occur whether the context was released normally (by the master explicitly releasing its context), or abnormally (by a change in management state, detection of an insane context by a watchdog timer, etc.). Other triggering events may also be defined.

Once a SEE has been deployed to a particular network element, it may allow application components to be developed which may utilize the capabilities provided by that node, without the development of a protocol. For example, an application component resident on a softswitch may initiate telephone calls by making use of the same Application Program Interface (“API”) which may be used by the softswitch's native software. API may include an interface between an operating system and various application programs. In another example, an Application Component resident on a mobile computing device may access a Mobile Information Devide Profile (“MIDP”) API or Mobile Execution Environment (MExE) API if implemented on the device.

An Application Component accessing such a local API may be part of the service in question. In addition, the Application Component may communicate with the underlying functionality using abstract events. These events may be sent to an “adapter” which in turn accesses the API. This technique allows the Application Component accessing the functionality in question to be co-resident with the implementation of the API (and adapter), or remote from the API (and adapter), transparently to the Application Component itself.

It should be noted that adapters themselves may include Application Components which provide a “translation” service between a generic, abstract event model, and a specific API or protocol. Thus, adapters may be created which implement interfaces to APIs such as MIDP, PersonalJava, etc., traditional protocols such as TCAP, SIP, HTTP, etc., or remote APIs provided by CORBA, Java RMI, or any other communication mechanism.

The present invention enables inter-node interactions required by a service to be greatly reduced so that the service may make efficient use of network resources.

The present invention provides a service designer, network engineer or other entity a variety of possible ways of deploying software to a network. The service may be designed and deployed in a way which makes optimal and/or beneficial use of resources, while addressing the various issues surrounding network cost, operations administration management (“OAM”), provisioning, upgradability, etc. One possible way a service may be deployed is a centralized SEE node approach. When this is the optimal solution, it may be employed.

The present invention relates to efficient use of network resources. By having the option of placing a particular function within a service on a node where it naturally fits according to its functional couplings, the inter-node communication may be reduced. As a result, the overall processing costs of the service may be minimized and efficiencies are enhanced.

Generally, protocol encoding and decoding are expensive operations. Further, when a service talks (or otherwise communicates) to another node to invoke a function, it generally involves a context switch, for example, which is also expensive.

The present invention facilitates downward scalability as well as upward scalability. For example, in the event that a small service provider desires a minimum-cost network, SEE service functionality may be provided on an existing special purpose node in the network (such as a softswitch, web server, etc.). This may eliminate the need for a separate SEE node.

Further, a mechanism for scaling up service processing capabilities in a network may involve adding more SEE nodes. However, this may prove to be more complicated because a way to distribute queries to different SEE nodes will have to be discovered and implemented.

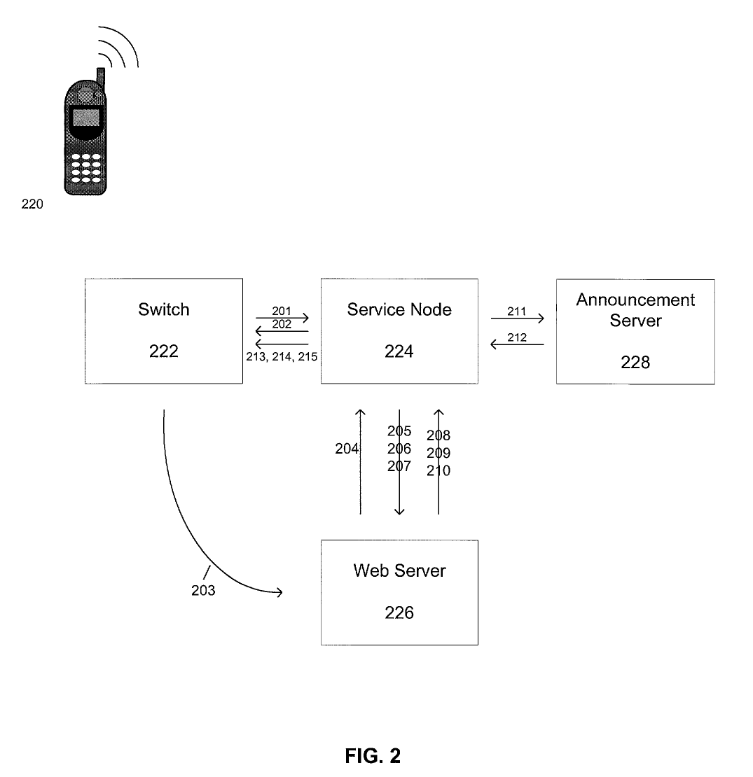

FIG. 2 illustrates an example of a system with inefficient use of typical inter-node interactions. FIG. 2 is an example of inter-node interactions as required by a commercial credit card service using standard protocol-based inter-node signaling. An object, such as a cell phone 220 or other communication mechanism, may send a request which may be received by a switch. Switch 222 may send an initial request 201 to a central node, such as service node 224. Service node 224 may contain programmable features and other capabilities. Confirmation may be sent to the switch, as shown by 202. Switch 222 may then set up a connection to web server 226, via connection 203. Web server 226 may then send instructions to service node 224, as shown by 204. Service node 224 may request web server 226 to prompt the caller for identification information, such as card number, PIN, called party number and other information, as shown by 205, 206, and 207. Web server 226 may then respond with the collected information, including card number, PIN and called party number, as shown by 208, 209 and 210.

Service node 224 may query an Announcement Server 228 (or other entity capable of forwarding information to another entity, such as a credit card company, for example) for card validity and other operations and information, via 211. A credit card server or other similar mechanism may also be implemented. Announcement Server 228 may then forward the information to the associated credit card company. Announcement Server 228 may respond with card authorization, as shown by 212. Server Node 224 may then send a request for charging information and/or other information to switch 222, as shown by 213. Service node 224 may also send a request to disconnect the IP connection, as shown by 214. Also, service node 224 may send a request to route the call to an appropriate destination, as shown by 215.

As illustrated by FIG. 2, the current system is highly inefficient and overly tedious. The system may be particularly onerous if the user inadvertently enters an incorrect PIN or other identification which may involve re-entry of requested information and confirmation information. The current system may involve a large overhead and high inefficiencies.

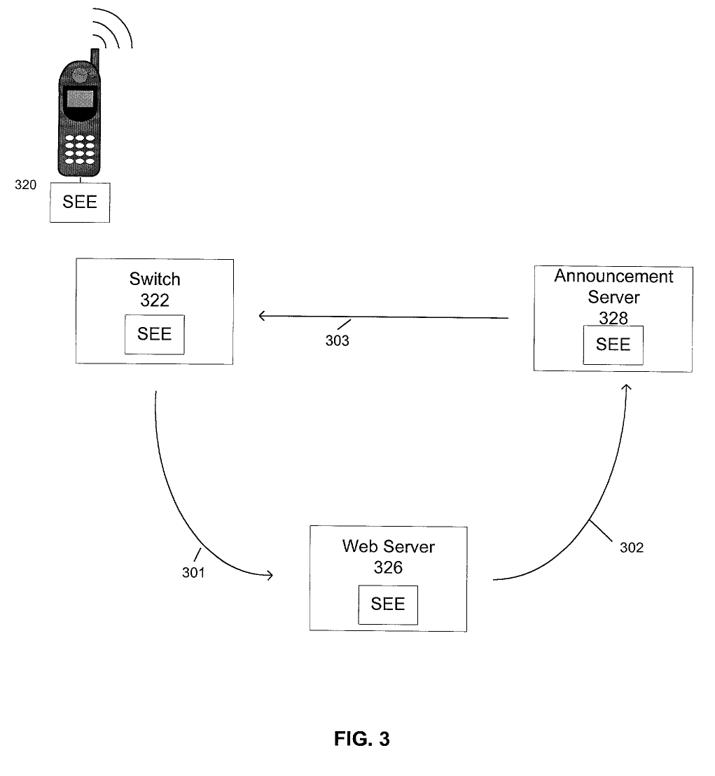

FIG. 3 illustrates a system where services have been distributed, according to an embodiment of the present invention. This example illustrates greatly simplified interactions for implementing service functionality using a service which has been distributed to SEEs running on each of the nodes. In addition to reducing the amount of messaging required, the need for a centralized service node has been eliminated thereby increasing efficiencies and reducing overhead and costs.

Switch 322 may receive a signal from a mobile or other device, such as cell phone 320. The SEE in switch 322 may determine that a card service is invoked and connect to a web server 326, as shown by 301. Service logic in web server 326 may collect the requested information, which may include card number, PIN, and called party number. Other information may also be collected. A query may be sent to Announcement Server 328, as shown by 302. Service logic in Announcement Server 328 may receive authorization where an “authorization successful” event may be sent to logic in switch 322, via 303. Service logic in switch 322 may store received information, such as billing information, drop the connection to web server 326, route the call and perform other operations.

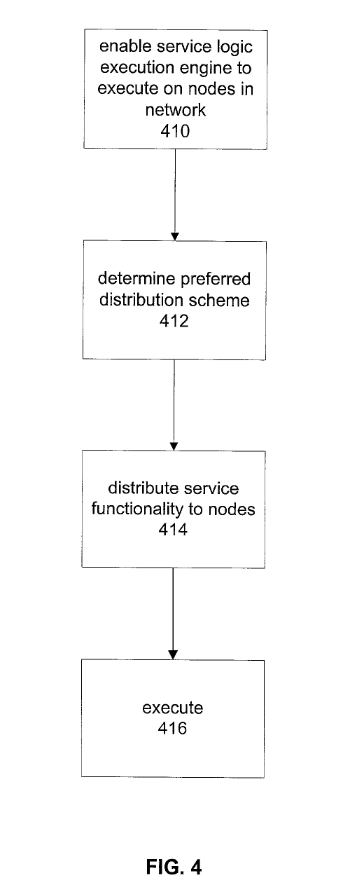

FIG. 4 illustrates an example of a flowchart for enabling distribution of service functionality across network elements in a network, according to an embodiment of the present invention. At step 410, a service logic execution engine (or other execution mechanism) may be used to enable service logic to execute on one or more nodes in a system. Step 412 may determine a preferred distribution scheme which may involve the determination of node placement, for example. The step of determining a preferred distribution scheme may further involve considering various factors, such as location of physical resources, minimization of inter-node interactions, efficient use of resources, natural couplings of associated service software and other efficiency considerations. At step 414, the present invention may enable distribution of service functionality to the nodes in the network in accordance with the distribution scheme. Each SEE may be informed of the locations (and other information) to which application components are distributed, to enable event passing between the application components during execution. Other factors and considerations may also be determined. At step 416, the service may be executed, in accordance with the present invention.

The present invention provides more flexible engineering of network computing resources based on the actual needs of the customer, the resource requirements of the service and other relevant factors.

According to an embodiment of the present invention, the computing resources used by a service may be easily scaled up or down, which may be further accomplished transparently to the service itself. For example, a service may be deployed in one network to a pre-existing node (e.g., a softswitch) to use existing computing resources, thereby minimizing hardware costs. In another network, the same (or similar or related) service may be deployed to multiple parallel dedicated services providing very high transaction throughput. Thus, more efficient use of computing resources may be accomplished. By co-locating services with functions to which they are tightly coupled, processing efficiency may be optimized and/or realized. For example, client GUI software may be executed in an end-user's client device thereby off-loading a server which may otherwise drive the GUI remotely using HTML, for example.

According to another embodiment of the present invention, more efficient use of network bandwidth between nodes may be accomplished. Since application components may co-reside with the functions to which they are tightly coupled, fewer messages may be sent between network nodes to perform a given function. This flexibility of engineering may allow for more easy and accurate satisfaction of requirements of individual service providers. For example, hardware costs may be minimized while throughput of services may be scaled to an appropriate level a service provider (or other entity) may require over time. This makes the service solutions of the present invention more attractive to customers, resulting in increased sales of service solutions and the networks elements that enable such features.

Other embodiments and uses of the invention will be apparent to those skilled in the art from consideration of the specification and practice of the invention disclosed herein. The specification and examples should be considered exemplary only.

What is claimed is:

1. A system for enabling distribution of service functionality across network elements in a network comprising:
a) a service logic execution engine for enabling service logic to execute on one or more nodes in the network;
b) a determination means for determining a preferred distribution scheme wherein the distribution scheme involves placement of nodes; and
c) a distribution means for distributing service functionality to nodes in accordance with the distribution scheme.

2. The system of claim 1 wherein the distribution scheme involves executing where one or more associated physical resources are located.

3. The system of claim 1 wherein the distribution scheme comprises a selection function to determine one or more nodes to be invoked.

4. The system of claim 3 wherein the selection function comprises executing an algorithm.

5. The system of claim 1 wherein the distribution scheme involves reducing inter-node interactions.

6. The system of claim 1 wherein the distribution scheme involves making efficient use of network resources.

7. The system of claim 1 wherein the distribution scheme involves considering one or more natural couplings of associated service software.

8. The system of claim 1 wherein one or more service logic execution engines execute on one or more participating nodes in the network.

9. The system of claim 1 wherein multiple parallel servers are capable of executing a service wherein the throughput is scalable to a desired level.

10. A method for enabling distribution of service functionality across network elements in a network comprising the steps of:
a) enabling service logic to execute on one or more nodes in the network;
b) determining a preferred distribution scheme wherein the distribution scheme involves placement of nodes; and
c) distributing service functionality to nodes in accordance with the distribution scheme.

11. The method of claim 10 wherein the distribution scheme involves executing where one or more associated physical resources are located.

12. The method of claim 10 wherein the distribution scheme comprises a selection function to determine one or more nodes to be invoked.

13. The method of claim 12 wherein the selection function comprises executing an algorithm.

14. The method of claim 10 wherein the distribution scheme involves reducing inter-node interactions.

15. The method of claim 10 wherein the distribution scheme involves making efficient use of network resources.

16. The method of claim 10 wherein the distribution scheme involves considering one or more natural couplings of associated service software.

16. The method of claim 10 wherein one or more service logic execution engines execute on one or more participating nodes in the network.

17. The method of claim 10 wherein multiple parallel servers are capable of executing a service wherein the throughput is scalable to a desired level.

18. A processor readable medium comprising processor readable code for enabling distribution of service functionality across network elements in a network comprising:
a) execution code that causes a processor to enabling service logic to execute on one or more nodes in the network;
b) determination code that causes the processor to determine a preferred distribution scheme wherein the distribution scheme involves placement of nodes; and
c) distribution code that causes the processor to distribute service functionality to nodes in accordance with the distribution scheme.

19. The processor readable medium of claim 18 wherein the distribution scheme involves executing where one or more associated physical resources are located.

20. The processor readable medium of claim 18 wherein the distribution scheme comprises a selection function to determine one or more nodes to be invoked.

21. The processor readable medium of claim 20 wherein the selection function comprises executing an algorithm.

22. The processor readable medium of claim 18 wherein the distribution scheme involves reducing inter-node interactions.

23. The processor readable medium of claim 18 wherein the distribution scheme involves making efficient use of network resources.

24. The processor readable medium of claim 18 wherein the distribution scheme involves considering one or more natural couplings of associated service software.

25. The processor readable medium of claim 18 wherein one or more service logic execution engines execute on one or more participating nodes in the network.

26. The processor readable medium of claim 18 wherein multiple parallel servers are capable of executing a service wherein the throughput is scalable to a desired level.
